(19) United States
(12) Patent Application Publication
(10) Pub. No.: US 2007/0133125 A1
(43) Pub. Date: Jun. 14, 2007

(54) Magnetic head

(75) Inventor: Yukimasa Yokoyama, Nagano (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/411,253

(22) Filed: Apr. 26, 2006

(30) Foreign Application Priority Data
Dec. 12, 2005 (JP) 2005-357860

(51) Int. Cl. G11B 5/147

(52) U.S. Cl. 360/126

(57) ABSTRACT

A magnetic head has an upper magnetic pole layer, a lower magnetic pole layer, and a gap layer between the upper magnetic pole layer and the lower magnetic pole layer, with data being recorded by magnetizing the surface of a recording medium with magnetic field leaking from the gap layer. The gap length of the left and right sides of the gap layer in the width direction are formed non-symmetrically.

### BACKGROUND OF THE INVENTION

1. Field of the Invention

The present invention relates to a magnetic head wherein an upper magnetic pole layer and a lower magnetic pole layer are formed on a substrate with a gap layer formed between the magnetic pole layers, and to a manufacturing method thereof.

2. Description of the Related Art

A type of magnetic head primarily used in information storage devices is a dual type having a recording device and a reproducing device using a magnetoresistive device (MR device) in a single head unit.

Generally, the recording device is configured of an upper magnetic pole layer and a lower magnetic pole layer, a gap layer between the magnetic pole layers, and a coil, with a magnetic field being generated by flowing electric current through the coil.

The surface of the recording medium is magnetized with the magnetic field leaking from the gap layer, thereby recording data.

In order to handle increased recording density for recording information using such a magnetic head, the amount of data recorded per increment of area on the recording medium (i.e., recording density) needs to be increased.

Improving recording density is achieved by realizing improved performance of the recording medium and the higher-frequency operation of the recording circuit, in addition to improved capabilities of the recording device.

Accordingly, one way of increasing the recording density would be to reduce the gap length of the magnetic head. Reducing the length of the gap enables the interval of each bit of data to be recorded to be reduced, and accordingly, the number of bits in each track on the recording medium is increased, thereby enabling a greater amount of data to be written.

Another way to increase the recording density would be to increase the number of tracks which can be recorded on the recording medium. Generally, the number of tracks which can be recorded on a recorded medium is expressed in terms of TPI (track per Inch), and TPI performance of a recording device can be improved by reducing the head dimensions (gap width) determining the track width.

On the other hand, increasing the recording density of the recording medium in this way results in noise from the effects of the magnetic field leaking from the left and right side faces in the width direction of the gap layer (known as side-fringing magnetic field), which leas to the problem in deterioration of data reproduction properties (S/N ratio).

Proposals have been made regarding techniques to reduce this side-fringing magnetic field which occurs at the gap layer of the magnetic head so as to prevent reduction in reproduction properties.

Now, Japanese Unexamined Patent Application Publication No. 08-007223 proposes a technique for deteriorating the magnetic properties of a part of the face of the upper magnetic pole layer and lower magnetic pole layer which faces recording medium, to a predetermined depth from the recording medium, thereby magnetically realizing a form wherein undershooting and side-fringe magnetic field can be prevented.

Specifically, the shape is not realized with physical working such as ion milling or the like, but is realized in a virtual manner by deteriorating the magnetic nature of a part of the magnetic pole layers.

Japanese Unexamined Patent Application Publication No. 08-007223 states that undershooting and side-fringe magnetic field can be effectively prevented while preventing instability in head floating, decrease in yield, deterioration in working precision, etc., owing to physical working (e.g., grinding the magnetic pole layers by ion milling).

Conventionally, the issue of product quality has been addressed by detecting noise in reproduction properties of products before shipping, and in the event that noise which markedly deteriorates the reproduction properties is detected, the product is discarded as being defective.

However, in recent years, higher recording density for information recording has led to an increase in rejects due to noise.

A particular problem is that, of the causes of products determined to be defective, in most cases, the noise which causes adverse effects occurs due to side-fringe magnetic field at positions where the skew angle of the magnetic head is great.

FIG. 9 illustrates a side-fringe magnetic field in a conventional arrangement, and is a diagram wherein a recording device 40 is viewed from the face opposing a recording medium 50.

In FIG. 9, applying an electrical current to the coil generates a magnetic field 60 between lower magnetic pole layer 22 and upper magnetic pole layer 24, and data is written to the recording medium by the magnetic filed leaking from a gap layer 23.

Note that the gap length 28 here is the length of the gap spacing at the gap layer 23 (the length in the thickness direction of the gap layer), and gap width 29 is the width of the gap layer 23 (the length of the head slider in the width direction).

Generally, the magnetic field 60 generated at the gap layer 23 is thought to be such that there is no leakage from the left and right sides of the gap layer 23.

The reason is that magnetic particles which have been magnetized by the magnetic flux curving around the left and right sides of the gap layer 23 are magnetized facing various directions, so data reliability is low.

Also, the width of the track on the recording medium 50 is designed to be around the same width as that of the gap layer 23, so the magnetic flux curving around the side of the gap layer 23 causes magnetization interference at edge portions between adjacent tracks. This creates noise, leading to deterioration in reproduction properties.

FIGS. 10A through 10C illustrate examples of bits magnetized by side-fringe magnetic field, wherein FIG. 10A illustrates an example of a magnetization pattern on a recording medium, FIG. 10B illustrates an example of a bit magnetized in a curved shape, and 10C illustrates an example of a bit magnetized in a straight shape.

Curved magnetic disturbance such as shown in FIG. 10B occurs at the edge portions of a bit (one piece of recorded data) 70 due to the side-fringe magnetic field.

FIG. 11 is a diagram illustrating the relation between recorded data and the magnetic head at a position where the skew angle is great.

In FIG. 11, the magnetic head 10 is inclined as to the circumference direction (track direction) of the recording medium at a predetermined angle, and data is recorded with the magnetic head 10 tilted at the predetermined angle, so the bits 70 are also inclined with regard to the track by the same angle.

Large curves are formed on the inner side of the skew angle at the edge portions of the bits 70, as indicated by reference symbol C. The greater the curvature is, the greater the adverse effect of noise is.

Such curvature of the edge portions of the bits 70 occur due to the side-fringe magnetic field, meaning that noise can be reduced if the amount of magnetic field leaking from the left and right sides in the width direction of the gap layer 23 can be controlled.

One conceivable way to reduce the side-fringe magnetic field is to reduce the gap length 28, etc., but this would reduce the magnetic field for recording on the recording medium, i.e., lead to deteriorated recording performance, which restricts large-scale reduction, and any practical application of this method will require further research.

### SUMMARY OF THE INVENTION

The present invention has been made in light of the above-describe problems, and accordingly it is an object of the present invention to improve the quality of magnetic heads and information recording devices by reducing the adverse effects of noise at bit edge portions without markedly reducing reproduction properties, and to improve yield in product manufacturing at the stage of noise testing.

In light of the above problems, the present Inventor has found that adverse effects of noise at the bit 70 edge portions at the time of recording can be reduced with no loss in recording performance, if the amount of leaking magnetic field can be reduced on one side of the gap layer 23 (the side at which curvature due to the side-fringe magnetic field is markedly manifested) as a way of reducing side-fringe magnetic field.

More specifically, the principle is to reduce the leaking magnetic field at the side of the gap layer 23 toward the inner edge side on the recording medium 50 in the event that the device design is such that the skew angle is great toward the outer edge of the recording medium 50, and to reduce the leaking magnetic field at the side of the gap layer 23 toward the outer edge side on the recording medium 50 in the event that the device design is such that the skew angle is great toward the inner edge of the recording medium 50.

That is to say, the amount of magnetic field leaking from the left and right sides of the gap layer 23 in the width direction is controlled so as to be non-symmetrical, by forming the gap layer 23 of the magnetic head 23 so as to be non-parallel or so that the shape of the left and right edge portions are non-symmetrical.

Thus, according to one aspect of the present invention, a magnetic head comprises: an upper magnetic pole layer; a lower magnetic pole layer; and a gap layer between the upper magnetic pole layer and the lower magnetic pole layer; wherein data is recorded by magnetizing the surface of a recording medium with magnetic field leaking from the gap layer; and wherein the gap length of the left and right sides of the gap layer in the width direction are non-symmetrical, thereby enabling adverse effects of noise at edge portions of bits to be reduced at the time of recording, while maintaining recording performance.

Also, the magnetic head may assume an angle as to the tangential direction of a track when positioned at an inner edge side or an outer edge side of the recording medium, with the gap length of the gap layer being formed smaller at the side situated on the inner side of the angle, thereby preventing deterioration of reproduction properties at positions with great skew angle.

As described above, according to the present invention, the amount of magnetic field leaking from the left and right sides of the gap layer in the width direction is controlled so as to be non-symmetrical by forming the gap layer of the magnetic head so as to be non-parallel or such that the shape of the left and right edge portions are non-symmetrical, whereby the quality of magnetic heads and information recording devices is improved by reducing the adverse effects of noise at bit edge portions without markedly reducing reproduction properties, and consequently improving yield in product manufacturing at the stage of noise testing.

### BRIEF DESCRIPTION OF THE DRAWINGS

FIGS. 1A and 1B are diagrams illustrating the configuration of a recording device and reproducing device of a recording head according to an embodiment of the present invention, wherein FIG. 1A illustrates a side view of the magnetic head and the device portion thereof as viewed from the side of the magnetic head, and FIG. 1B illustrates device portion thereof as viewed from the side facing the recording medium;

FIG. 2 is a diagram illustrating the concept of skew angle;

FIG. 3 is a diagram illustrating a side-fringe magnetic field according to a first embodiment;

FIG. 4A through 4D is a diagram illustrating a first step and a second step in the manufacturing method of the magnetic head device portion according to the first embodiment;

FIG. 5A through 5D is a diagram illustrating third through sixth steps in the manufacturing method of the magnetic head device portion according to the first embodiment;

FIG. 6 is a diagram illustrating the side-fringe magnetic field according to a second embodiment;

FIG. 7 is a diagram illustrating a second step in the manufacturing method of the magnetic head device portion according to the second embodiment;

FIG. 8 is a diagram illustrating the side-fringe magnetic field according to a third embodiment;

FIG. 9 is a diagram illustrating a side-fringe magnetic field in a conventional magnetic head device portion;

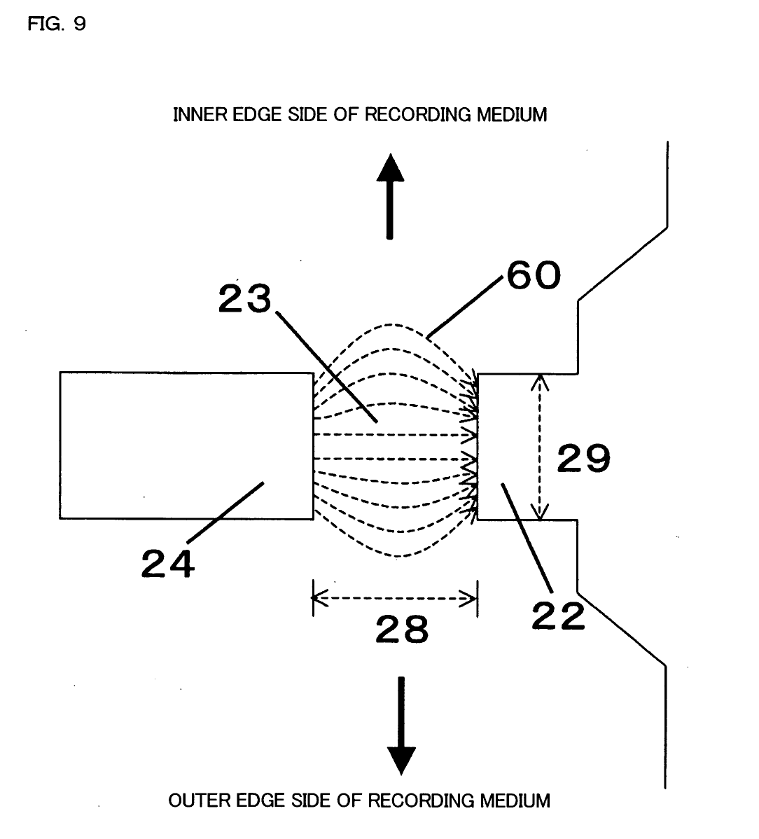

FIGS. 10A through 10C illustrate examples of bits magnetized by side-fringe magnetic field, wherein FIG. 10A illustrates an example of a magnetization pattern on a recording medium, FIG. 10B illustrates an example of a bit magnetized in a curved shape, and 10C illustrates an example of a bit magnetized in a straight shape; and

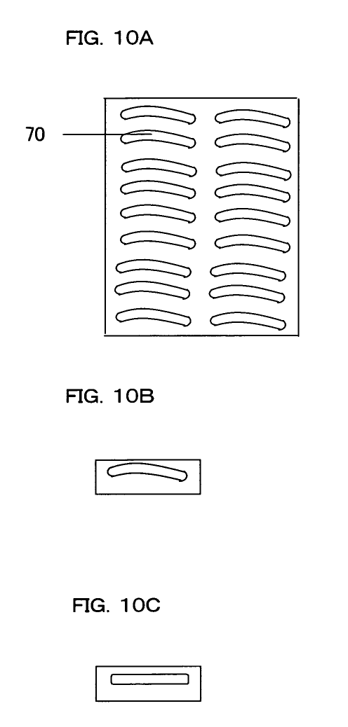

FIG. 11 is a diagram illustrating the relation between recorded data and the magnetic head at a position where the skew angle is great.

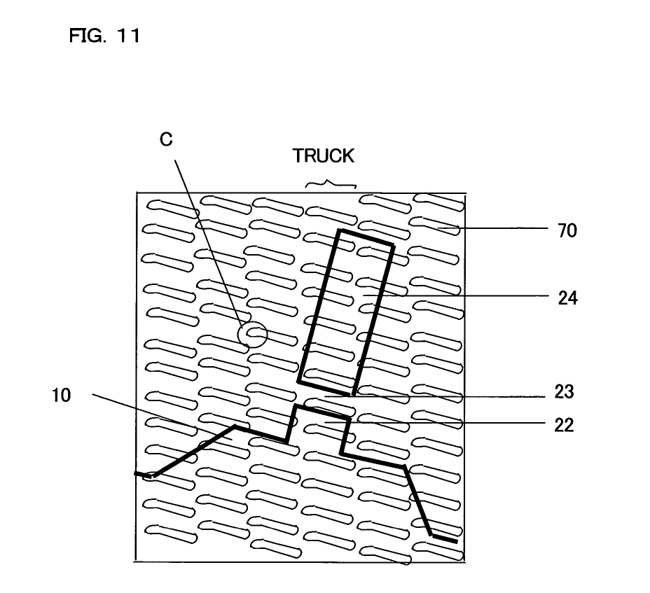

### DESCRIPTION OF THE PREFERRED EMBODIMENTS

Embodiments will now be described with reference to the attached drawings.

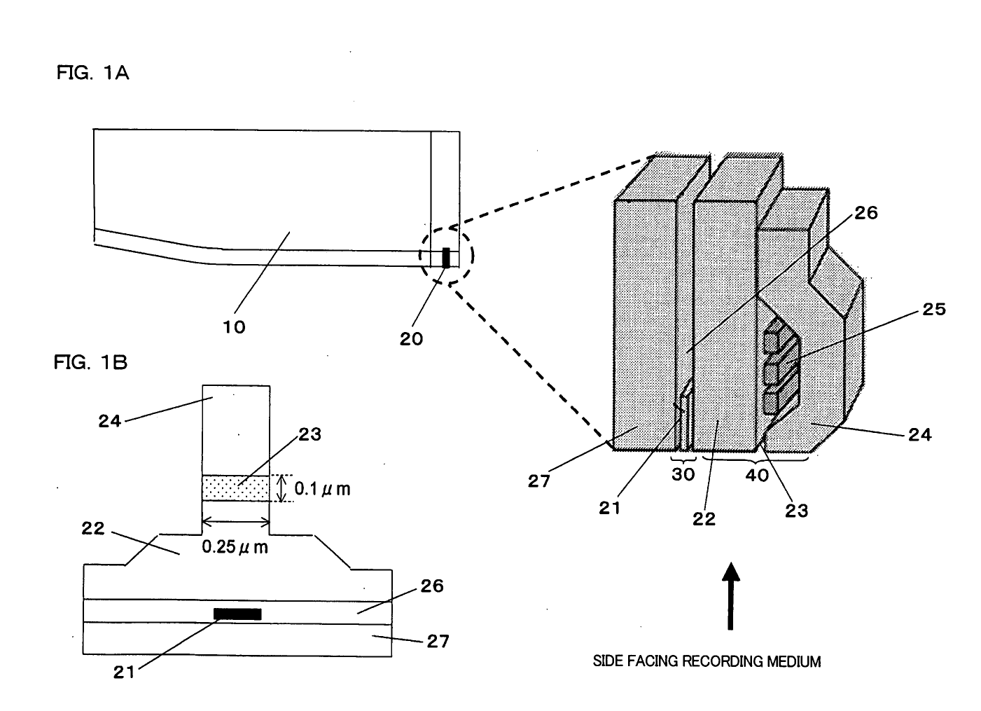

FIGS. 1A and 1B are diagrams illustrating the configuration of a recording device and reproducing device of a recording head according to the present invention, wherein FIG. 1A illustrates a side view of the magnetic head 10 and the device portion 20 thereof as viewed from the side of the magnetic head 10, and FIG. 1B illustrates device portion 20 thereof as viewed from the side facing the recording medium.

In FIG. 1A, reference numeral 21 denotes an MR device, 22 denotes a lower magnetic pole layer, 23 denotes a gap layer, 24 denotes an upper magnetic pole layer, 25 denotes a coil, 26 denotes a non-magnetic layer, and 27 denotes a substrate.

The reproducing device 30 is configured of the MR device 21, of which the resistance value changes proportionately to the intensity of magnetic field, the MR device 21 being included in the overall configuration by way of the non-magnetic layer 26.

Minute magnetic fields on the face of the recording medium are detected by the magnetoresistive effect and converted into voltage, thereby reproducing data. Well-known examples include anisotropic magnetoresistive (AMR) devices, giant magnetoresistive (GMR) devices, tunneling magnetoresistive (TMR) devices wherein a tunneling current is used to generate MR effects, and so forth.

Now, an induction electromagnetic converter is used for the recording device 40, layered on the reproducing device 30.

The induction thin-film electromagnetic converter serving as the recording device 40 has a lower magnetic pole layer 22, a gap layer 23, an upper magnetic pole layer 24, and a coil 25 supported by an insulating film.

The tip portions of the lower magnetic pole layer 22 and upper magnetic pole layer 24 face one another across a very thin gap layer 23, and data is recorded by the magnetic field generated at the gap layer 23.

Note that the lower magnetic pole layer 22 and the upper magnetic pole layer 24 are connected with each other on the side opposite to the side facing the recording medium, so as to form a magnetic circuit.

In FIG. 1B, the gap layer 23 in the present embodiment has the dimensions of 0.1 μm for the gap length 28 and 0.25 μm for the gap width 29.

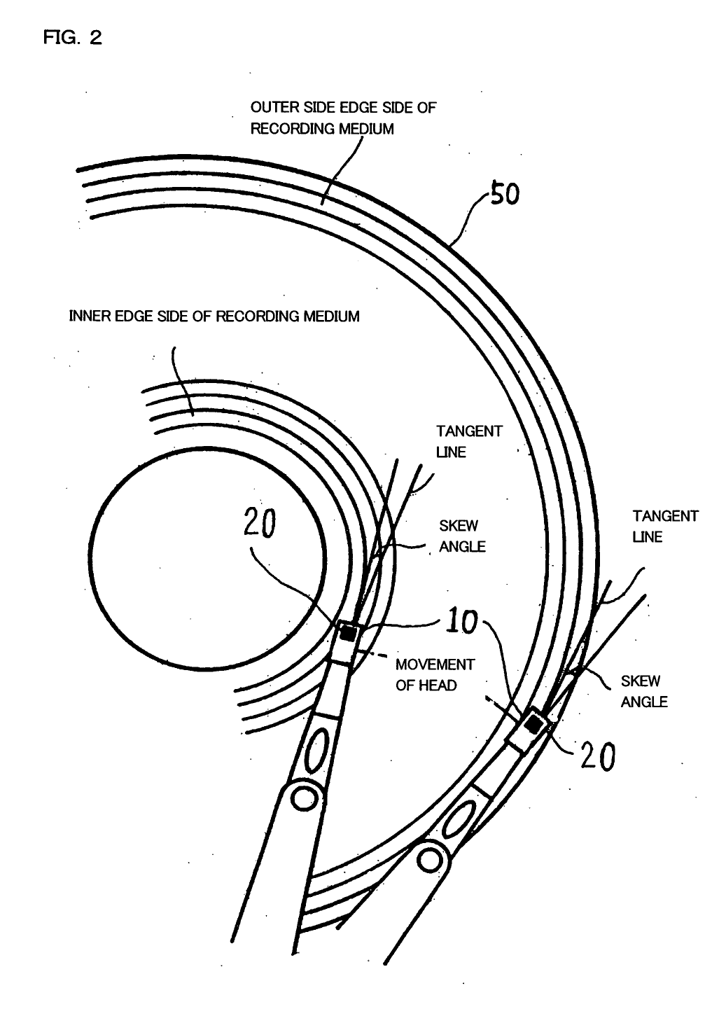

Next, FIG. 2 illustrates the concept of skew angle. In FIG. 2, the great number of tracks which would actually be on the recording medium 50 are for the most part omitted from the drawing for the sake of facilitating description, and two on-track examples of the magnetic head 10 are shown, one at the outer edge portion and the other at the inner edge portion.

There is a skew angle between the tracks of the recording medium 50 and the magnetic head 10 in either case, with the orientation of the device portion 20 being off in the circumference direction of the recording medium 50.

Note that what is called the “skew angle” is the inclination of the magnetic head 10 on the recording medium 50 as to the circumferential direction (tangential direction) of the recording medium.

As shown in FIG. 2 with on-track examples of the magnetic head 10, the skew angle is represented with the tangent line of the track as a reference. With such a representation, the inclination of the magnetic head 10, i.e., the skew angle is a positive angle when the magnetic head 10 is situated at the inner edge. On the other hand, the inclination of the magnetic head 10, i.e., the skew angle is a negative angle when the magnetic head 10 is situated at the outer edge.

Note that with the present embodiment, the magnetic head 10 is situated on the outer edge side of the recording medium at a greater skew angle than with the inner edge side of the recording medium. Specifically, the magnetic head 10 is situated on the inner edge side at a skew angle of +6°. On the other hand, the magnetic head 10 is situated on the outer edge side at a skew angle of −15°.

Next, a first embodiment according to the present invention will be described.

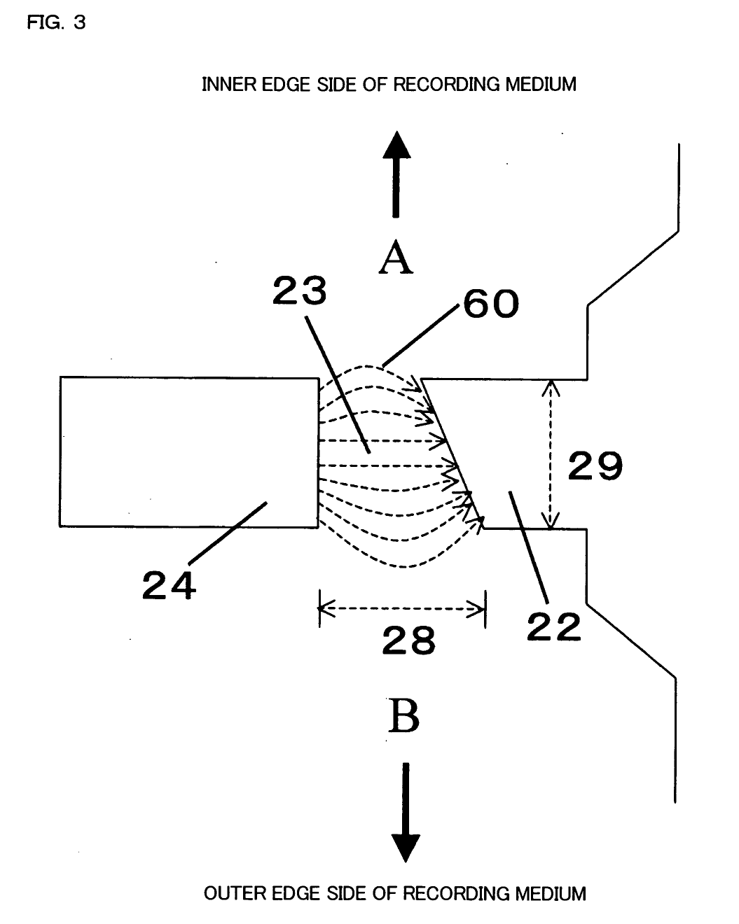

FIG. 3 is an illustrating of the side-fringe magnetic field in the first embodiment, viewing the recording device 40 from the side facing the recording medium 50.

With the arrangement shown in FIG. 3, electric current flows through the coil, which generates a magnetic field 60 between the lower magnetic pole layer 22 and the upper magnetic pole layer 24, and data is written to the recording medium 50 by the magnetic field 60 leaking from the gap layer 23.

Note that in this description, the “gap length 28” refers to the length of the gap spacing at the gap layer 23, and “gap width 29” is the width of the gap layer 23.

With the recording device 40 according to the present embodiment, the skew angle is greater at the outer edge side of the recording medium than the inner edge side of the recording medium, so the lower magnetic pole face of the gap layer is tilted such that the gap length 28 of the gap layer 23 of the magnetic head 10 at the inner edge side of the recording medium is smaller.

Consequently, the leaking magnetic field of the gap layer 23 toward inner edge side of the recording medium can be reduced, and accordingly curving of the edge portions of bits 70 due to the side-fringe magnetic field where the skew angle of the magnetic head is great can be prevented.

Note that the gap spacing at the side indicated by the reference symbol A where the gap length 28 is smaller is designed so as to be around 80% to 90% of the gap spacing at the side indicated by the reference symbol B where the gap length 28 is greater. With the present embodiment, the inclination angle is around 2.3° to 4.6°.

This configuration wherein the gap length 28 is slightly reduced exhibits little deterioration in recording performance.

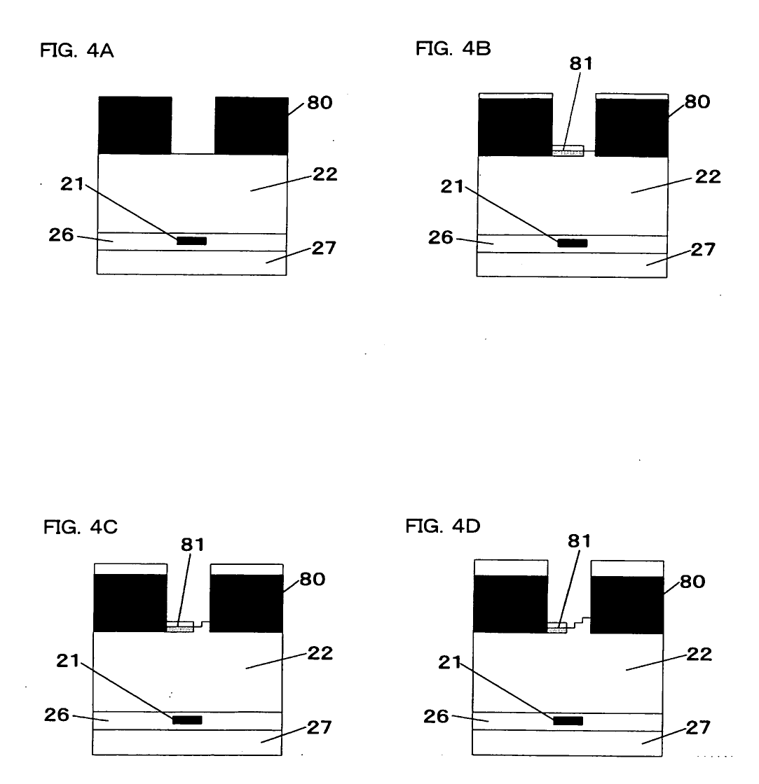

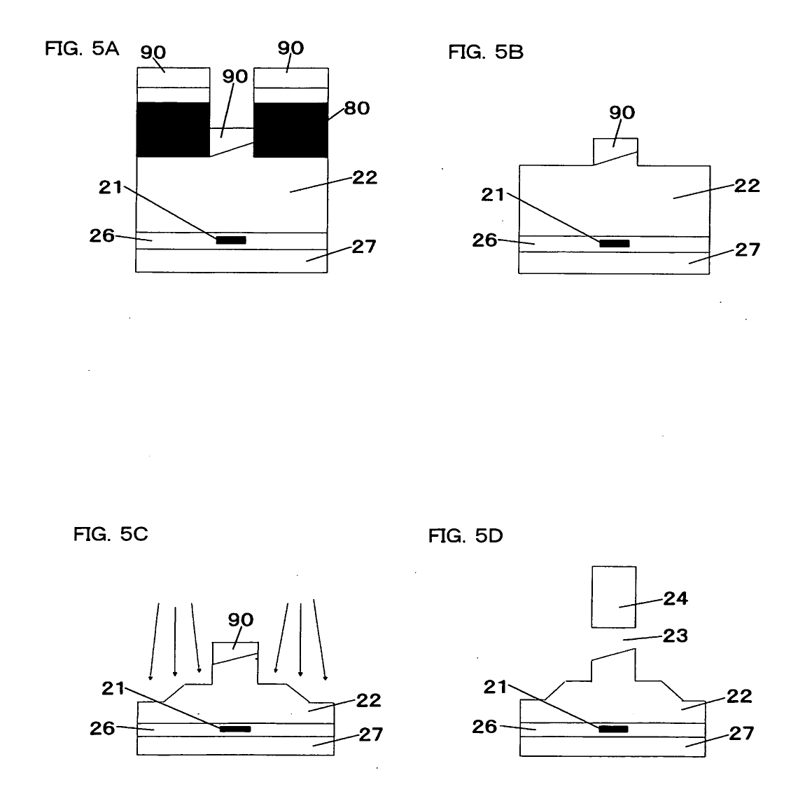

Next, the manufacturing method for the device portion 20 of the magnetic head 10 will be described with reference to FIG. 4 and FIG. 5.

FIG. 4 and FIG. 5 are views of the device portion 20 of the magnetic head 10 from the side facing the recording medium. The device portion 20 has a lower magnetic pole layer 22 and non-magnetic layer 26 layered on the substrate 27. The lower magnetic pole layer 22 is layered on the non-magnetic layer 26, and the MR device is interpositioned in the non-magnetic layer 26.

In FIG. 4A denotes the first step in the manufacturing method of the device portion 20. The first step is for determining a gap layer formation region.

First, as shown in FIG. 4A, the non-magnetic layer 26 having the MR device 21 therewithin is layered on the upper face of the substrate 27, and then following further layering the lower magnetic pole layer 22 on the non-magnetic layer 26, resist is applied to the entire face and patterned, thereby forming a resist layer 80 with the gap layer formation region exposed.

Next, in FIG. 4B through FIG. 4D illustrate the second step in the manufacturing method of the device portion 20.

In the second step, the surface of the lower magnetic pole layer 22 is formed in a predetermined shape.

In FIG. 4B, a mask 81 is formed on the exposed face of the lower magnetic pole layer 22, and the lower magnetic pole layer 22 is further deposited to a predetermined thickness. Subsequently, the mask 81 is removed, and a mask 81 of a narrower range than before is formed as shown in FIG. 4C, and the lower magnetic pole layer 22 is further deposited to a predetermined thickness. Subsequently, the mask 81 is removed, and a mask 81 of a narrower range than before is formed as shown in FIG. 4D, and the lower magnetic pole layer 22 is further deposited to a predetermined thickness.

Repeating this processing enables the exposed face of the lower magnetic pole layer 22 to be inclined.

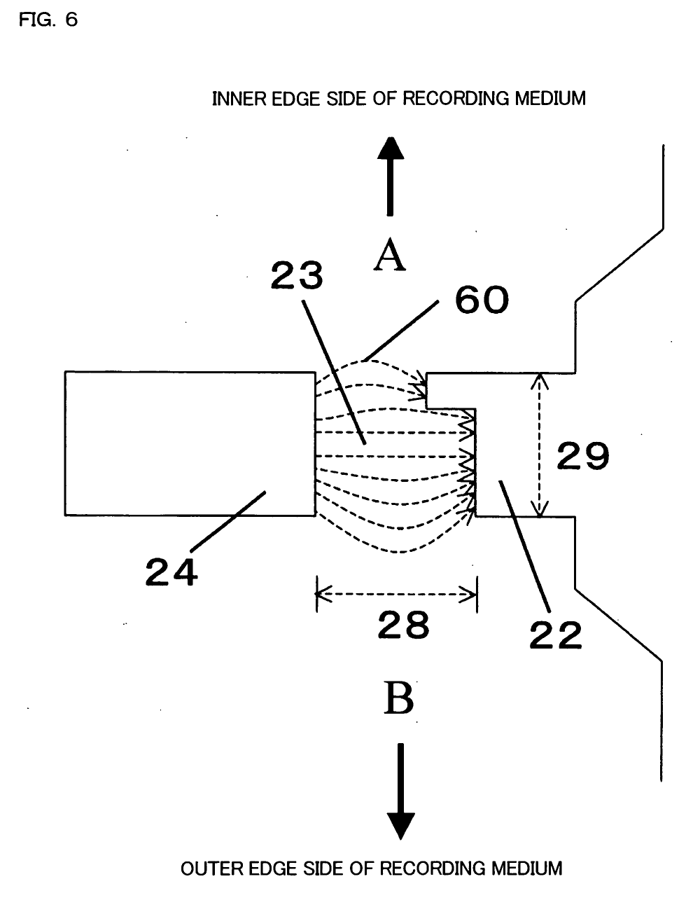

Now, while a stepped shape is shown in FIG. 6 to facilitate description, the smaller the amount of shifting of the masking range performed each time the above process is repeated is, the smoother the inclined face will be.

Accordingly, the following description will proceed under the assumption that a smooth inclined face has been formed.

In FIG. 5A denotes the third step in the manufacturing method of the device portion 20. This third step is a sputtering step.

As shown in FIG. 5A, SiO₂ (silicon dioxide) 90 is sputtered onto the upper face of the resist layer 80 and the exposed face of the lower magnetic pole layer 22.

In FIG. 5B denotes the fourth step in the manufacturing method of the device portion 20. This fourth step is a step for removing the resist layer 80. Removing and lifting off the resist layer 80 leaves only the SiO₂ 90 formed directly on the face of the lower magnetic pole layer 22. This remaining SiO₂ 90 becomes the final gap layer.

Also, after this step, the surface of the lower magnetic pole layer 22 not covered by the SiO₂ 90 is exposed.

In FIG. 5C denotes the fifth step in the manufacturing method of the device portion 20. This fifth step is a step for performing ion milling for the lower magnetic pole layer 22.

In the fifth step, ion milling is performed on the lower magnetic pole layer 22 as indicated by the arrows, thereby removing the unmasked portions of the lower magnetic pole layer 22.

In FIG. 5D denotes the sixth step in the manufacturing method of the device portion 20. This sixth step is gap layer 23 formation step.

Here, the SiO₂ 90 is removed, and a gap layer 23 is formed by sputtering on the lower magnetic pole layer 22 from which the SiO₂ 90 has been removed, the sputtering specifically being performed with Al₂O₃ (aluminum oxide) to a thickens of 0.1 μm, and the upper magnetic pole layer 24 is layered thereupon.

Due to the above processes, an arrangement can be formed wherein one of the magnetic pole faces of the lower magnetic pole layer 22 and upper magnetic pole layer 24 is inclined such that the gap length 28 of the gap layer 23 of the head 10 is smaller on the inner edge side of the recording medium.

FIG. 6 is a diagram illustrating the side-fringe magnetic field according to a second embodiment, viewing the recording device 40 from the side facing the recording medium 50.

With the arrangement shown in FIG. 6, electric current flows through the coil, which generates a magnetic field 60 between the lower magnetic pole layer 22 and the upper magnetic pole layer 24, and data is written to the recording medium 50 by the magnetic field 60 leaking from the gap layer 23.

Note that in this description, the “gap length 28” refers to the length of the gap spacing at the gap layer 23, and “gap width 29” is the width of the gap layer 23.

With the recording device 40 according to the present embodiment, the skew angle is greater at the outer edge side of the recording medium than the inner edge side of the recording medium, so the magnetic pole face of one or the other of the lower magnetic pole layer 22 and the upper magnetic pole layer 24 situated across the gap layer 23 is formed in a stepped manner such that the gap length 28 of the gap layer 23 of the magnetic head 10 at the inner edge side of the recording medium is smaller.

Consequently, the leaking magnetic field of the gap layer 23 toward inner edge side of the recording medium can be reduced, and accordingly curving of the edge portions of bits 70 due to the side-fringe magnetic field where the skew angle of the magnetic head is great can be prevented.

Note that the gap spacing at the side indicated by the reference symbol A where the gap length 28 is smaller is designed so as to be around 80% to 90% of the gap spacing at the side indicated by the reference symbol B where the gap length 28 is greater.

This configuration wherein the gap length 28 is slightly reduced exhibits little deterioration in recording performance.

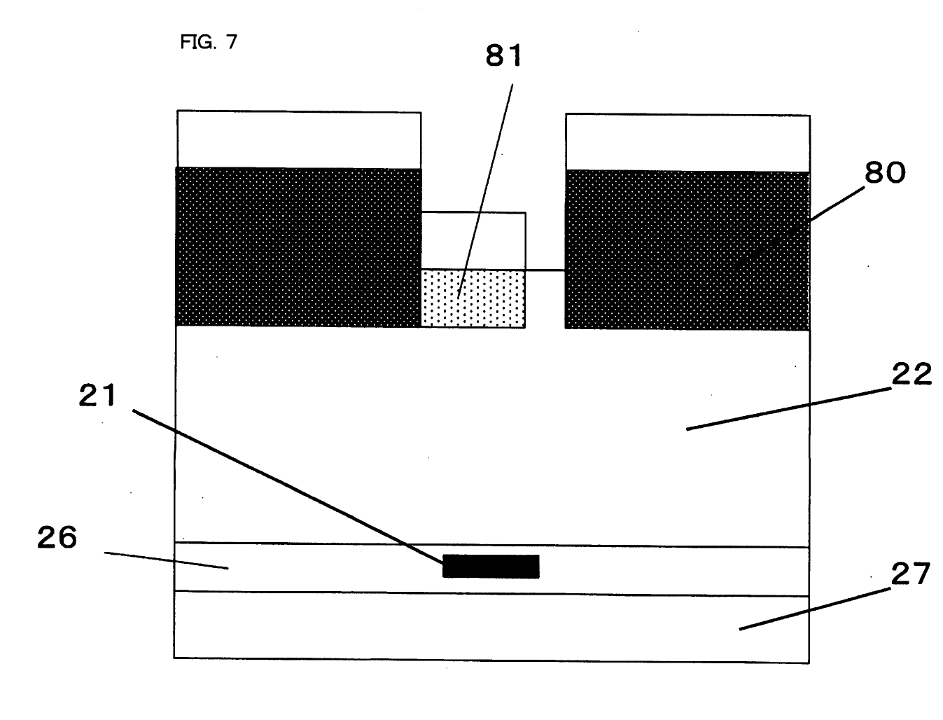

Next, just the second step in the manufacturing method of the device portion 20 of the magnetic head 10 will be described with reference to FIG. 7. The other steps are the same as those described in the first embodiment, and accordingly, description thereof will be omitted. FIG. 7 is a view of the device portion 20 of the magnetic head 10 from the side facing the recording medium.

The device portion 20 has a lower magnetic pole layer 22 and non-magnetic layer 26 layered on the substrate 27. The lower magnetic pole layer 22 is layered on the non-magnetic layer 26, and the MR device is interpositioned in the non-magnetic layer 26, and a resist layer 80 for exposing the gap layer formation region is formed on the lower magnetic pole layer 22.

Following formation of the resist layer 80, a mask 81 is formed on the exposed face of the lower magnetic pole layer 22 such that the gap length 28 of the gap layer 23 of the magnetic head 10 toward the inner edge side of the recording medium is smaller, thereby providing the lower magnetic pole layer 22 with stepped thickness.

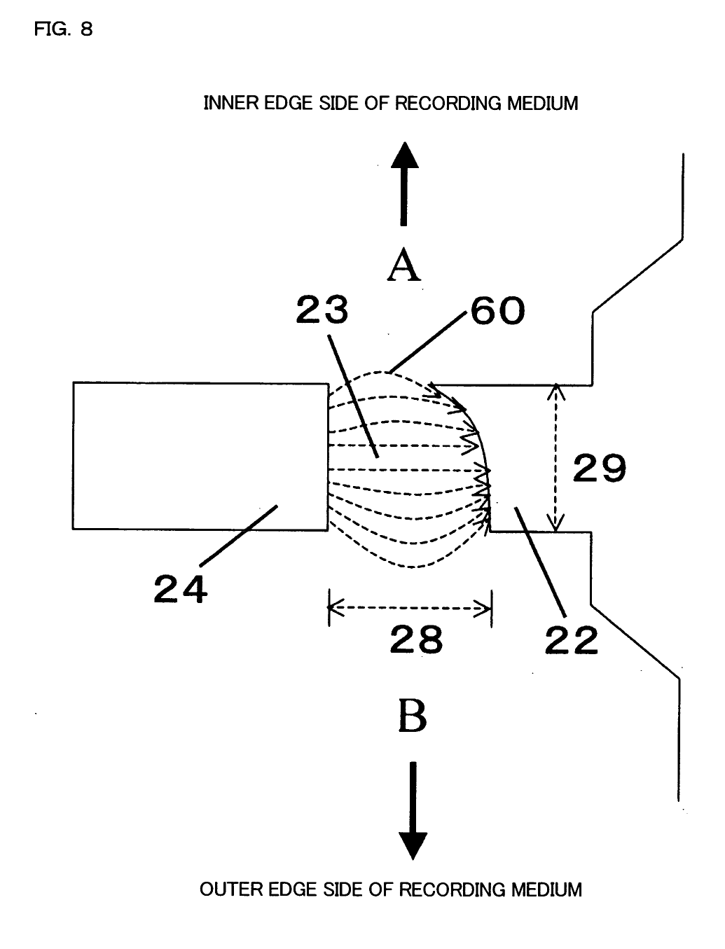

FIG. 8 is a diagram illustrating the side-fringe magnetic field according to a third embodiment, viewing the recording device 40 from the side facing the recording medium 50.

With the arrangement shown in FIG. 8, electric current flows through the coil, which generates a magnetic field 60 between the lower magnetic pole layer 22 and the upper magnetic pole layer 24, and data is written to the recording medium 50 by the magnetic field 60 leaking from the gap layer 23.

Note that in this description, the “gap length 28” refers to the length of the gap spacing at the gap layer 23, and “gap width 29” is the width of the gap layer 23.

With the recording device 40 according to the present embodiment, the skew angle is greater at the outer edge side of the recording medium than the inner edge side of the recording medium, so the magnetic pole face of one or the other of the lower magnetic pole layer 22 and the upper magnetic pole layer 24 situated across the gap layer 23 is formed in a curved manner such that the gap length 28 of the gap layer 23 of the magnetic head 10 at the inner edge side of the recording medium is smaller.

Consequently, the leaking magnetic field of the gap layer 23 toward inner edge side of the recording medium can be reduced, and accordingly curving of the edge portions of bits 70 due to the side-fringe magnetic field where the skew angle of the magnetic head is great can be prevented.

Note that the gap spacing at the side indicated by the reference symbol A where the gap length 28 is smaller is designed so as to be around 80% to 90% of the gap spacing at the side indicated by the reference symbol B where the gap length 28 is greater.

This configuration wherein the gap length 28 is slightly reduced exhibits little deterioration in recording performance.

Of the steps of the manufacturing method for manufacturing the device portion 20 of the magnetic head 10 according to the present embodiment, those other than the second step are the same as those in the first embodiment described above, so description thereof will be omitted here.

The difference in the second step between the present embodiment and the first embodiment is as follows. That is to say, the shape according to the present embodiment can be realized by gradually increasing the amount of shifting of the mask 81 as compared to the second step in the first embodiment.

In other words, this shape can be realized by making the amount of shifting to be smaller closer to the side A where the gap length 28 is to be made small, and by making the amount of shifting to be greater closer to the side B where the gap length 28 is to be made great.

Of course, the present invention is by no way restricted to the embodiments described above and illustrated in the drawings, and various modifications can be made without departing from the essence of the invention.

As described above, according to the present invention, the amount of magnetic field leaking from the left and right sides of the gap layer in the width direction is controlled so as to be non-symmetrical in the left and right directions by forming the gap layer of the magnetic head so as to be non-parallel or such that the shape of the left and right edge portions are non-symmetrical, whereby the quality of magnetic heads and information recording devices is improved by reducing the adverse effects of noise at bit edge portions without markedly reducing reproduction properties, and consequently improving yield in product manufacturing at the stage of noise testing.

What is claimed is:

1. A magnetic head comprising:
an upper magnetic pole layer;
a lower magnetic pole layer; and
a gap layer between said upper magnetic pole layer and said lower magnetic pole layer, said gap layer leaking magnetic field so as to record data by magnetizing the surface of a recording medium, said gap layer having the gap length being non-symmetrical of the left and right sides of said gap layer in the width direction.

2. The magnetic head according to claim 1, said magnetic head assuming an angle as to the tangential direction of a track when positioned at an inner edge side or an outer edge side of said recording medium;
wherein the gap length of said gap layer is smaller at the side situated on the inner side of said angle.

3. The magnetic head according to claim 2, wherein the face of said lower magnetic pole layer facing the gap layer is formed as an inclined face.

4. The magnetic head according to claim 2, wherein the face of said lower magnetic pole layer facing the gap layer is formed as a curved face.

5. The magnetic head according to claim 2, wherein the face of said lower magnetic pole layer facing the gap layer is formed as a stepped face.

6. An information storage device comprising:
information medium driving means for rotationally driving a disc-shaped recording medium with a motor; and
recording and/or recording-and-reproducing means having
an upper magnetic pole layer,
a lower magnetic pole layer, and
a gap layer between said upper magnetic pole layer and said lower magnetic pole layer, said gap layer leaking magnetic field so as to record data by magnetizing the surface of a recording medium, said gap layer having the gap length being non-symmetrical of the left and right sides of said gap layer in the width direction.

7. The information storage device according to claim 6, said recording and/or recording-and-reproducing means assuming an angle as to the tangential direction of a track when positioned at an inner edge side or an outer edge side of said recording medium;
wherein the gap length of said gap layer is smaller at the side situated on the inner side of said angle.

8. A method for manufacturing a magnetic head having
an upper magnetic pole layer,
a lower magnetic pole layer, and
a gap layer between said upper magnetic pole layer and said lower magnetic pole layer, said gap layer leaking magnetic field so as to record data by magnetizing the surface of a recording medium, said method comprising
forming said gap layer with a gap length in a non-symmetrical manner in the left and right directions.

9. A method for manufacturing a magnetic head according to claim 8, wherein a mask is formed at a portion where the gap length is to be smaller along the width direction of said gap layer.
